(19) United States
(12) Patent Application Publication
(10) Pub. No.: US 2003/0004726 A1
(43) Pub. Date: Jan. 2, 2003

(54) Access control arrangement and method for access control

(76) Inventors: Meinrad Niemoeller, Holzkirchen (DE); Reinhart Vogl, Muenchen (DE)

Correspondence Address: BELL, BOYD & LLOYD, LLC, P. O. BOX 1135, CHICAGO, IL, 60690-1135, US

(21) Appl. No.: 10/182,172

(22) PCT Filed: Nov. 22, 2001
(86) PCT No.: PCT/EP01/13609

(30) Foreign Application Priority Data
Nov. 27, 2000 (EP) 00125914.2

(51) Int. Cl. G10L 21/00

(52) U.S. Cl. 704/273

(57) ABSTRACT

A speech-controlled access control arrangement (1) comprising at least one access control device (3′, 5′, 7′, 9′) to release or block access, in particular to a delimited room (7, 9), technical device (3, 5) or data or telecommunications network, and a mobile speech input unit (11) connected to the access control device via a telecommunications connection, in particular a wire-free telecommunications connection.

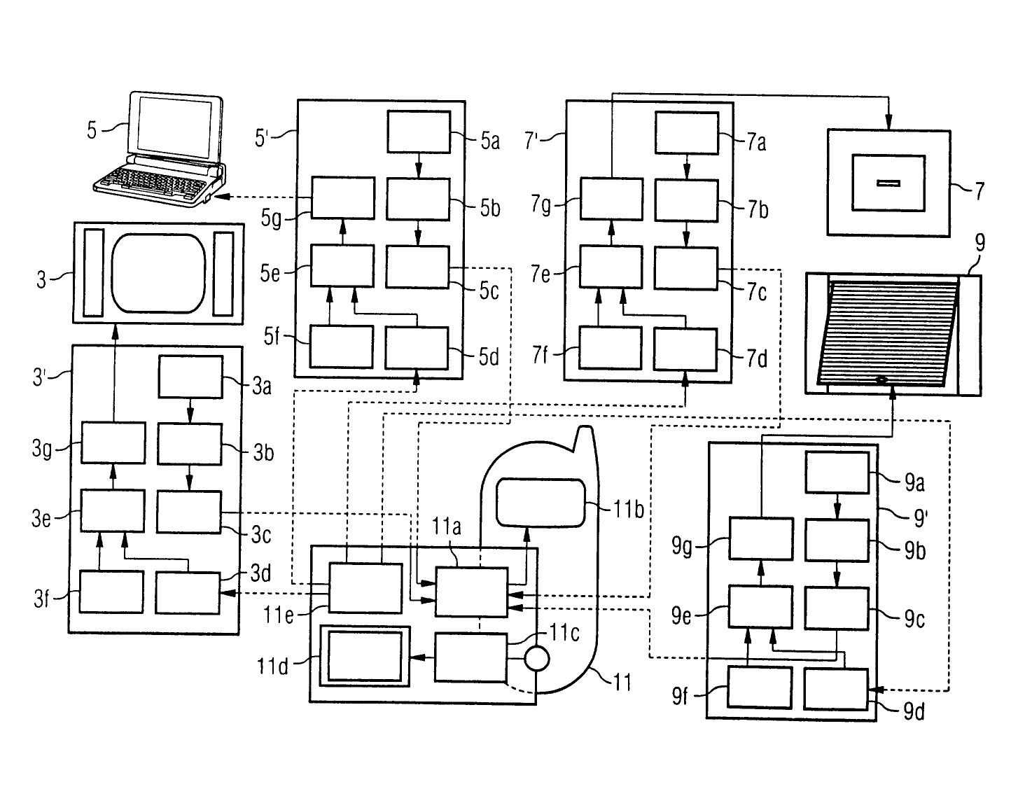

The invention relates to a method for access control according to the precharacterizing clause of claim 10 and also a corresponding access control arrangement.

The control of access to delimited physical areas, complicated technical devices with demanding operation and high risk potential in the event of erroneous operations and also to data or telecommunications networks constitutes a significant security aspect in the use of such areas or systems. With the increasing large number of areas or systems in daily life, to which particular access conditions apply, the number of keys and codes permitting access in each case and in the possession of many users increases sharply. Keeping them securely, on the one hand, and immediate and reliable access thereto, on the other hand, are therefore becoming increasingly problematic.

For this reason, many attempts have been made to make life easier for the users by standardizing the “keys” needed for various rooms, devices, networks etc. However, first of all compatibility problems occur here between various access control systems with different security levels and, secondly, the consequences associated with a loss or theft of the “key” for the user, on the one hand, and for the systems secured by this one key, on the other hand, overall become more and more critical.

Work has therefore been carried out for a long time on possibilities of using biometric data about the users—for example the papillary lines, the retinal pattern or the voice or speech—for access control. In principle, these “keys” cannot be lost and are also relatively difficult to forge and, above all, their use is extremely simple for the user.

Electronic speaker verification or identification uses methods similar to those of voice recognition. However, their aim is not the conversion of the spoken word into text but in the identification or verification of a person on the basis of their speech. The known speaker verification systems are relatively complex and expensive and therefore have not become very widespread. This has also been added to by the problem that conventional speech recognition systems have to be initialized or trained to the user or users in a process also designated “enrolment”. This problem has a particularly detrimental effect when a user has to gain access or wishes to gain access to various rooms, buildings, devices, networks or the like by means of speaker identification and in each case has to train the individual system in advance.

It is therefore an object of the invention to specify a speech-controlled access control system which is simple, can be implemented cost-effectively and is easy for the user or users to handle, and also a corresponding method for access control.

With regard to its device aspect, this object is achieved by an access control arrangement having the features of claim 1 and, with regard to its method aspect, is achieved by a method having the features of claim 10.

The invention includes the basic idea of dividing up the overall sequence of the access control by speaker identification (from the speech input until the release or blocking of the access) between two subsystems or method subsequences, one of the subsystems or one of the method steps being useable for a large number of access control situations. What is concerned here is a mobile speech input unit, which carries out part of the speaker identification operation, while the other part of the overall arrangement—more precisely: a large number of possible overall arrangements—comprises an access control device in each case effecting the actual access control. In said device, another part of the speaker identification is carried out, and in particular, a dictionary used for the authorization of the user is also stored here.

In a preferred configuration of the arrangement, the or each access control device comprises, in addition to an appropriate control device dictionary store, a control word transmitting unit for transmitting words from the stored dictionary to the speech input unit, and the speech input unit correspondingly has a control word receiving unit for receiving the control words, a microphone and a low-frequency stage connected downstream for the speech input, a speaker feature extraction stage (speech recognizer) and a speaker feature transmitting stage for transmitting an extracted speaker feature set to the respective access control device. The latter additionally has an appropriate speaker feature receiving stage, a speaker feature reference store for storing speaker features of predetermined users and also a speaker feature comparison unit which, on the basis of the result of a comparison between the currently determined speaker features with previously stored speaker features, produces an access release signal or else an access blocking signal.

The mobile speech input unit expediently comprises a buffer, connected between the control word receiving unit and the speaker feature extraction stage or the speech recognizer, for the selected control or identification words received from the access control device, and likewise the access control device expediently has a speaker feature buffer, connected between the speaker feature receiving stage and the speaker feature comparison unit, for the speaker features received from the speech input unit. These buffers can be permanent or semipermanent and, for one and the same access control device, interacting with one and the same speech input unit in an overall system comprising a plurality of speech input units and/or access control devices, depending on the actual system configuration, may ensure more or less long-term storage of a control or identification word set or the features of a speaker wishing to gain access.

According to the above, the speech input and the feature extraction take place in the mobile speech input unit. However, in the preferred embodiment, the knowledge about the words which are to be spoken by a user wishing to gain access for the purpose of speaker verification is not contained in said mobile speech input unit. As soon as a speech input unit is connected to an access control unit, the speech input unit transmits, for example, a user name or user code to the access control device. The latter transmits back words or a text, using which the speaker verification for the user wishing to gain access is to be carried out. (These words or this text will be referred to here in brief as “control words”.) In a preferred embodiment, these control words are selected from a predefined list (dictionary) via a random generator.

The next task of the mobile speech input unit is then to present these words spoken by the user in a verification dialog, to request the user to input speech and to record his spoken work. For this purpose, displays known per se with menu guidance and audio front ends are used.

Then, using speech recognition structures and algorithms known per se—in particular on the basis of a hidden Markov model or neural network—the aforementioned extraction of the speaker features is carried out. These features are then transmitted back to the access control device and are there compared with previously stored speaker feature sets or vectors of authorized speakers—in particular with the speaker feature vector of the specific user identified by the name or user code. A classification stage of the access device, carried out by using a threshold value discriminator, then decides, as a result of a statistical evaluation, whether the speech patterns are sufficiently similar to each other and, as a result of this comparison, outputs an access release signal or access blocking signal. It goes without saying that the arrangement can be trained or initialized for an individual authorized user and access is released only for the latter; in general, however, the speaker feature reference store of the access control device will have a plurality of speaker feature storage areas which can be addressed in each case via a user name or user code.

The communication between the speech input unit and the access control device or the access control devices expediently takes place by means of wire-free communication, in particular on a radio link. Currently preferred is a radio link based on the bluetooth or DECT standard (for example in the case of a cordless telephone) and the use of a mobile radio network with speech and data transmission in accordance with the GSM or UMTS standard. In this case, in particular the dictionary transmitting unit and the speaker feature receiving stage of the respective access control device, and the dictionary receiving unit and the speech feature transmitting stage of the speech input unit are constructed as radio transmitting and receiving units. In principle, the use of tried and tested infrared interfaces is also possible.

In the preferred embodiment of the speaker feature extraction stage with a phoneme-based hidden Markov model, it is not necessary for the previously stored speaker features used as a reference to have been obtained from the words currently used as control words. Instead, the access control device can predefine new control words for each user wishing to gain access and/or during each access attempt or else at periodic intervals, without renewed training of the speech recognizer in the speech input unit being required.

In this connection, the training or enrolment plays an important part. In principle, this has to be divided into two parts, namely the recording of a word or of a speech and the calculation of the features on the speech input unit, on the one hand, and the storage of the features with a speaker identification code on an access device, on the other hand. These two parts of the enrolment can also be carried out chronologically separately from each other, and in particular speaker features obtained once on a speech input unit can be transmitted to various access devices.

Overall, the proposed arrangement and the proposed method provide a large number of advantages as compared with known methods.

The words to be spoken in order to gain access authorization (according to a preferred embodiment of the invention) cannot be forged by means of previously produced audio recordings, since the access device decides randomly which words are to be spoken and analyzed in order to gain access authorization.

In the access devices, only the components for the word selection, reference feature storage and classification or threshold value discrimination have to be provided as components for speech verification, and this leads to simplification and reduction in costs on the part of the access devices.

Since the feature comparison and the classification or threshold value discrimination take place in the access device, the system overall is well protected against penetration from outside. A particularly high degree of encryption of the communication between the speech input unit and the access devices is not necessary, since the words used for the speaker verification are in any case not known before the initiation of the access procedure.

The processing-intensive part of the speaker verification, namely the feature extraction, takes place in the speech input unit, which can be used for a large number of access control tasks. This overall reduces the expenditure on hardware and software in the case of complex access control systems.

In the case of suitable implementation forms (mobile telephone, cordless telephone and the like), an audio front end (microphone, A/D converter, possibly digital signal processor), which is already present in any case, can be used on the side of the speech input unit.

The time-intensive part of the enrolment, namely the (in particular repeated) recording and feature extraction of a training dictionary, needs to be carried out only once in the speech input unit for various access control applications. Since the results are reused when logging in to a new—naturally system-compatible—access control device, this logging in is shortened substantially and, overall, the handling of the access system is simplified and made convenient for the user.

Advantages and expedient features of the invention otherwise emerge from the subclaims and the following outline description of exemplary embodiments, to some extent using the figure.

The latter shows, in the manner of a sketch in a functional block circuit diagram, a complex access control configuration 1 comprising a number of devices or objects or rooms to which access is controlled by speaker verification, specifically a television set 3, a computer system 5, a safe 7 and a garage door system 9, each of which has an access control unit 3′,5′,7′ and 9′, and a mobile telephone 11 as speech input unit.

The access control devices 3′ to 9′ each have a dictionary store 3a to 9a, a control word selection stage 3b to 9b connected thereto and a control word transmitting stage 3c to 9c connected to the latter for the storage, selection and transmission of control words to the speech input unit 11 for the speaker verification of a user wishing to gain access in each case.

Said speech input unit 11 has a control word receiving unit 11a for receiving the respective control words and a display unit 11b for displaying the control words to be spoken by the user. Furthermore, it has an audio front end 11c for the speech input by the user and a speaker feature extraction stage 11d connected to the audio front end, on the one hand, and to the control word receiving unit, on the other hand, and implemented as a speech recognizer with a hidden Markov model, and also a speaker feature transmitting stage 11e connected to the output of the speaker feature extraction stage 11d for transmitting speaker features extracted from the speech input to the access control devices 3′ to 9′. (To this extent, the functionality of the speech input unit 11 goes beyond that of a normal mobile telephone, but in the example it is assumed that the speech input unit is formed by an appropriately “armed” mobile telephone. The normal components of such a telephone are not illustrated and will not be described here).

The currently determined speaker features are received in the access control devices 3′ to 9′ in each case by a speaker feature receiving stage 3d to 9d, which in turn is connected to a speaker feature comparison unit 3e to 9e. The latter is further connected to a speaker feature reference store 3f to 9f for storing speaker features from a predetermined user group as a reference for the speaker verification, and is used to compare the currently determined concomitantly stored speaker feature vectors and to output a degree of agreement as a result of a statistical comparison operation.

Connected downstream thereof in each case is a classifier stage (threshold value discriminator) 3 g to 9 g for classifying the comparison result at a predetermined threshold value of the degree of agreement. This classifier stage ultimately outputs an access release signal or access blocking signal as a final control signal of the store verification on the basis of the result of the threshold value discrimination. The threshold values can be selected differently in the individual access control devices on the basis of the desired level of protection against unauthorized use of the respective room or system to be secured. Likewise, the dictionaries of the individual access control devices can be selected differently, and the extent of the control word set or control text respectively selected from the overall dictionary for the speaker verification can have a different size.

In this embodiment, the assignment of the user wishing to gain access is carried out by means of an evaluation (not illustrated) of data transmitted to the access control devices—which of course must have a mobile radio transmitting/receiving part—from the SIM card of the mobile telephone 1. This additionally increases the security against unauthorized access to the devices, since even the use of the mobile telephone 11 is only possible following activation of a PIN known exclusively to the user.

In a modified embodiment, not illustrated, the first step provided in the access procedure is the speaking of the name of the user and its transmission to the respective access control device for addressing a speaker feature reference store, which has a plurality of storage areas, that can be addressed via the user name, for speaker feature sets.

Another exemplary embodiment provides for the use of Bluetooth technology for the wire-free communication between a speech input unit and the access control devices. The speech input unit used here, in particular for the domestic sector, is for example a cordless telephone retrofitted with a Bluetooth module or else a PDA or handheld PC, into which the aforementioned speaker feature extraction stage has been integrated. The presence of the necessary audio components permits cost-effective implementation of the speech input unit in this case too.

The implementation of the invention is not restricted to the examples described above; within the scope of the dependent claims, a large number of variations on this implementation are possible which lie within the scope of the specialist trade.

1. A speech-controlled access control arrangement (1) having at least one access control device (3′, 5′, 7′, 9′) to release or block access, in particular to a delimited room (7, 9), technical device (3, 5) or data or telecommunications network, and a mobile speech input unit (11) connected to the access control device via a telecommunications connection, in particular a wire-free telecommunications connection.

2. The access control arrangement as claimed in claim 1, characterized in that
the or each access control device (3′, 5′, 7′, 9′) comprises a control device dictionary store (3a, 5a, 7a, 9a) for storing a predetermined dictionary,
a control word transmitting unit (3c, 5c, 7c, 9c) for transmitting words from the stored dictionary to the speech input unit (11) as control words,
a speaker feature receiving stage (3d, 5d, 7d, 9d) for receiving speaker features extracted in the speech input unit,
a speaker feature reference store (3f, 5f, 7f, 9f) for storing speaker features of predetermined users as feature vectors, and also
a speaker feature comparison unit (3e, 5e, 7e, 9e) for comparing currently determined speaker feature vectors with stored ones and for outputing an access release signal or access blocking signal as a function of the comparison result, and
the speech input unit (11) comprises a control word receiving unit (11a) for receiving the control words transmitted from the control device, a control word display unit (11b), means for speech input (11c), a speaker feature extraction stage (11d), connected to the means for speech input and at least indirectly to the dictionary receiving unit, for obtaining a speaker feature set and a speaker feature transmitting stage (lie) for transmitting the extracted speaker feature set to the access control device.

3. The access control arrangement as claimed in claim 2, characterized in that the speech input unit (11) comprises a control word buffer connected between the control word receiving unit (11a) and the speaker feature extraction stage (11d), and the access control device comprises a speaker feature buffer connected between the speaker feature receiving stage (3d, 5d, 7d, 9d) and the speaker feature comparison unit (3e, 5e, 7e, 9e).

4. The access control arrangement as claimed in claim 1 or 2, characterized in that the or each access control device (3′, 5′, 7′, 9′), in particular its control word transmitting unit (3c, 5c, 7c, 9c) and speaker feature receiving stage (3d, 5d, 7d, 9d), and the mobile speech input unit (11), in particular its control word receiving unit (11a) and speaker feature transmitting stage (11e), are constructed as radio transmitting and receiving units, in particular mobile radio transmitting or receiving units or Bluetooth or DECT transmitting and receiving units.

5. The access control arrangement as claimed in one of the preceding claims, characterized in that the mobile speech input unit (11) comprises means (11b) for user guidance during the speech input, based on the control values received from the access control device (3′, 5′, 7′, 9′).

6. The access control arrangement as claimed in one of the preceding claims, characterized in that the or each access control device (3′, 5′, 7′, 9′) has a selection device (3b, 5b, 7b, 9b), operating in particular on the random generator principle, for the case by case selection of a set of control words from the stored dictionary.

7. The access control arrangement as claimed in one of the preceding claims, in particular one of claims 2 to 6, characterized in that the speaker feature reference store (3f, 5f, 7f, 9f) of the or each access control device (3′, 5′, 7′, 9′) comprises a plurality of speaker feature storage areas which can be addressed via a user name or a user code, and the speech input unit (11) comprises a buffer (11b) for storing an input user name or user code, said buffer being connected to the speaker feature transmitting stage (11e) for transmission to the access control device in conjunction with the extracted speaker features.

8. The access control arrangement as claimed in one of the preceding claims, in particular one of claims 2 to 7, characterized in that the speaker feature extraction stage (11d) of the speech input unit (11) is implemented as a speech recognizer, in which a hidden Markov model or neural network suitable for speaker verification is implemented which is initialized or can be initialized for at least one user, in particular for a plurality of users.

9. The access control arrangement as claimed in one of the preceding claims, in particular one of claims 4 to 8, characterized in that a speech input unit (11) constructed as a mobile radio terminal is designed to transmit user data from the SIM card to the access control device, and
the access control device has an evaluation device for evaluating the transmitted user data in conjunction with data determined during the speaker feature extraction.

10. A method for access control, in particular to a delimited room (7, 9), technical device (3, 5) or data or telecommunications network, by evaluating the spoken word from at least one user, from which, using methods of speech recognition, a speaker feature set is derived, which is compared with at least one previously stored speaker feature set, access being released or blocked as a result of the comparison, characterized in that the extraction of the speaker features from the spoken word and the comparison of the speaker feature set with the previously stored speaker feature set is carried out in a distributed manner in a speech input device (11), on the one hand, and an access control device (3′, 5′, 7′, 9′), on the other hand.

11. The method as claimed in claim 10, characterized in that for the spoken word, previously stored control values from a dictionary are predefined, in particular selected on the random principle.

12. The method as claimed in claim 10 or 11, characterized in that the dictionary is stored in the access control device (3′, 5′, 7′, 9′), the selection of the control words is carried out in the access control device, and the selected control words are buffered in the speech input device (11) and output to the user within the context of user guidance.

13. The method as claimed in one of claims 10 to 12, in particular as claimed in claim 11, characterized by wire-free transmission of the selected control words from the access control device (3′, 5′, 7′, 9′) to the speech input unit (11) and of the speaker features from the speech input unit to the access control device.

14. The method as claimed in one of claims 10 to 13, characterized in that in the speech input unit (11), before the method is carried out, a hidden Markov model or a neural network for speech recognition is initialized in an enrolment, each speaker being identified by speaking identification words and a predetermined speaker feature set being extracted from the speech data spoken by him and being stored together with the user name or a user code.

15. Method as claimed in one of claims 10 to 14, in particular claim 14, characterized in that the speech data, together with the spoken control word and/or a corresponding phonetic transcription of the control word, are transmitted to an access control device and stored there in a speaker feature reference store.

16. The method as claimed in one of claims 10 to 15, characterized in that the process of enrolment is divided up into the steps
(1) of recording the control word and extracting the speaker features and
(2) of transmitting the features with the corresponding control word, the phonetic transcription and a user code or name to an access control device,
it being possible for step (2) to be carried out individually in each case for a plurality of access control devices.

17. The method as claimed in one of claims 10 to 16, characterized in that
for each comparison between a currently obtained speaker feature set and a previously stored speaker feature set, a degree of agreement between the speaker features is determined statistically,
discrimination of the degree of agreement is carried out with a predetermined threshold value and
access release is triggered only when the degree of agreement for the corresponding user lies above the threshold value.

18. The method as claimed in one of claims 10 to 17, characterized in that the storage of the control words in the dictionary store of the access control devices is in each case expanded by storing the corresponding phonetic transcription, in order to facilitate speech recognition on a phoneme basis.
